(19) United States
(12) Patent Application Publication
(10) Pub. No.: US 2015/0082424 A1
(43) Pub. Date: Mar. 19, 2015

(54) Active Web Content Whitelisting

(71) Applicant: Jayant Shukla, Sierra Madre, CA (US)

(72) Inventor: Jayant Shukla, Sierra Madre, CA (US)

(21) Appl. No.: 14/031,641

(22) Filed: Sep. 19, 2013

(51) Int. Cl. H04L 29/06

(52) U.S. Cl. CPC H04L 63/1408
USPC 726/22

(57) ABSTRACT

The disclosed invention is a new method and apparatus for using a white-list to authenticate active contents in web pages and removing all unauthorized active content received in the web pages. A computer system receives plurality of web pages from a web server. Web pages are scanned for plurality of active contents. A database includes attributes of plurality of active content that are permitted on the web page. A web page filtering components compares active content in web pages with the entries in the database. Any unauthorized active content in the page is removed. The modified web page is sent to the intended destination.

### BACKGROUND OF THE INVENTION

Almost every web page contains active content in the form of JavaScripts, JAVA files, executable files, browser plugins, etc. Active content is necessary for creating dynamic web pages, but it also enables an attacker to launch attacks on visitors of malicious or compromised websites. Attacks can also be launched by exploiting vulnerabilities in the website that otherwise do no host malicious content. For example, a Cross Site Scripting (XSS) attack becomes feasible when the input from a user is not properly validated. An attacker can trick a user into clicking a specially crafted link that points to the vulnerable site. The XSS vulnerability causes the website to send malicious code (JavaScript provided by the attacker as part of the link) to the victim's machine. By exploiting XSS vulnerabilities, attackers can steal cookies or launch an exploit to install malware. These XSS attacks can be persistent or non-persistent. In 2007, XSS vulnerabilities accounted for 84% of all security vulnerabilities [1]. Two of the top ten risks are associated with XSS [2] and according to SANS it is the #1 software error [3].

Web content filters protect clients from web-based exploits by blocking access to known malicious websites and by scanning web pages for known malicious content. Web application firewalls (WAF) prevent XSS attacks by scanning the incoming data and finding patterns that are consistent with an attack. Some WAFs rewrite URLs to prevent cross-site request forgery attacks. Kausik [4] describes a method to automate the classification of the URLs being access.

While web application firewalls can protect the server side from attacks, the clients remains vulnerable. An attacker can infect the client from a vulnerable website and then target banking applications by placing malware on the client computer or inside the browser. Preventing XSS attacks on the client side is much more difficult and not addressed adequately by content filters, client security software, or network firewalls.

Some client security software [5] can disable scripting for untrusted websites, but that may interfere with the proper functioning of websites and still does not address compromised websites. Microsoft IE has a built-in XSS filter, but it is limited in its effectiveness [6]. Hegli et al. [7] describe a method for controlling access to Internet resource, i.e. a server, based on a reputation index. They need prior information on the content to classify as “bad” and a new malicious content will likely evade detection. Davenport et al. [8] describe a method to detect malicious actions in web page content based on calls to functions that expose vulnerability. This approach too is a “black-list” approach that defines execution of certain functions as “bad”. Dunagan et al. [9] attempt to prevent third-party active content in a web page from accessing private information by generating proxy representation of those objects. Their approach prevents some malicious actions by third-party scripts, but it is not a complete solution and it does not solve the XSS problem. Sterland et al. [10] propose a variation of Dunagan et al. by isolating the execution of untrusted scripts from trusted scripts. They limit untrusted script that are downloaded at runtime from accessing sensitive resources.

Therefore, a need exists for systems and methods to protect clients from web-based attacks. The solution must not take away features of the web in order to improve security. The security mechanism should work seamlessly and without any input from the user. As the web becomes the dominant platform for applications, commerce, banking, etc., the security concerns increase. Such a solution will not only save corporations several billion dollars each year, but it will be critical in maintaining the integrity of government and financial network infrastructure and consumer computers.

### SUMMARY OF THE INVENTION

An objective of the present invention is to protect client computers when accessing a vulnerable, compromised, or malicious website. A method and system is provided for white-listing the contents of web pages to protect clients from web-based attacks and exploits by removing harmful components from the web pages being accessed by the clients. The present invention overcomes the problem based on traditional white-list and black-list based security solutions for blocking access to web-sites by authenticating the active components of individual web pages.

In accordance with an aspect of the invention, a web page received from a web server is scanned for active components; a hashing algorithm computes cryptographic hashes of active components; matching the cryptographic hashes with known cryptographic hashes for that web page; removing active content for which a cryptographic hash match was not made; forward the modified web page to its intended destination.

In accordance with another aspect of the invention the validation of active content in a web page is performed at a point in the network by first decrypting the web page; scanning the contents of the decrypted web page for active content; a hashing algorithm computes cryptographic hashes of active components; matching the cryptographic hashes with known cryptographic hashes for that web page; removing active content for which a cryptographic hash match was not made; forward the modified web page to its intended destination.

A benefit of using authentication of the contents of web pages is that it can prevent attacks originating from compromised and vulnerable web sites. A black and white list based method for blocking access to websites may not spot a recently compromised web site and permit access, which could result into attacks on the client computer. The task of generating a white list is simpler and can be automated much more efficiently compared to generating a black list of items to block.

Also described in this invention is a method for creating the white list rules for active content in a web page. In a deterministic approach for creating the rules, the web page for which the rule is to be created initiates the request and the rule server examines the page to create white-list rules for that page. Alternatively, the web pages can be scanned by a crawler to create a white list rule database. Finally, the communication between clients and web pages can be monitored and the collected information used for creating white list rules.

Another advantage of authenticating active content in web pages is that it can eliminate XSS attacks in an automated fashion. Instead of relying on heuristics to detect XSS attacks, which has limited effectiveness and can be bypassed, we can guarantee that no attacker supplied malicious code can be executed.

### BRIEF DESCRIPTION OF THE DRAWINGS

Various embodiments of the present invention taught herein are illustrated by way of example, and not by way of limitation, in the figures of the accompanying drawings, in which:

FIG. 1 illustrates a computer network system 100 for authenticating the active components of a web page that is consistent with one or more embodiments of the present invention.

FIG. 2 illustrates a control flow chart for authenticating active components in a web page that is consistent with one embodiment of the present invention.

FIG. 3 illustrates transformation of a web page based on authentication of active components 300, 302, 304, 306 present in the page and removal of unauthenticated components 302, 304, 306 that is consistent with one embodiment of the present invention.

FIG. 4 is a generalized diagram illustrating the process for creating rules for use in authentication of active content in a web page.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DESCRIPTION OF THE PREFERRED EMBODIMENT

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well-known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

In one embodiment of the present invention, authentication of active components in a web page and removal of unauthenticated active components is achieved on the network via a Network device. All connections to the Internet in a network of computing devices with plurality of operating systems are monitored. In another embodiment of the present invention, authentication of active components in a web page and removal of unauthenticated active components is achieved at the client computer via a process.

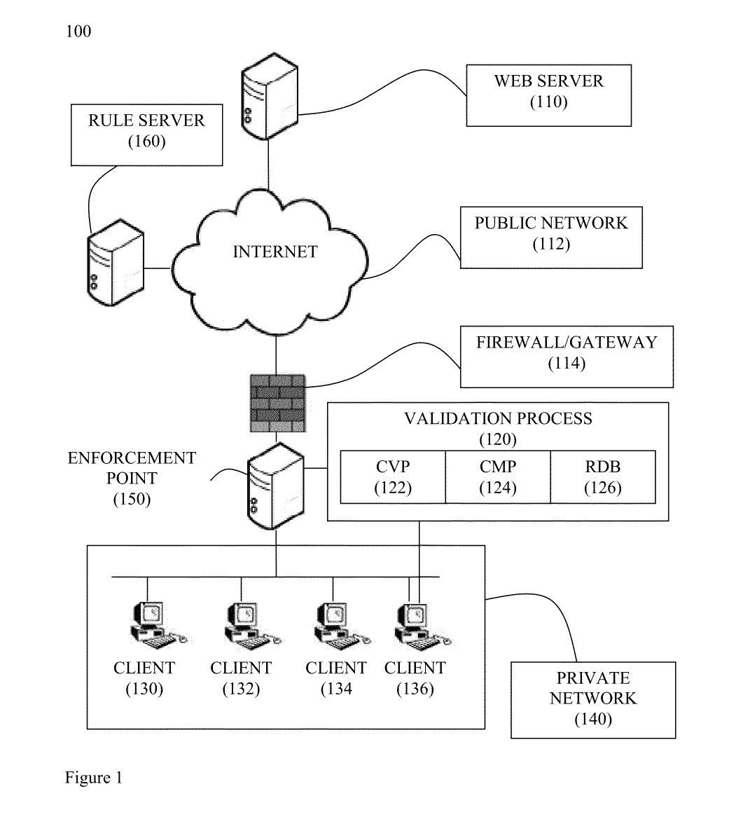

FIG. 1 illustrates a computer network system 100 that represents one or more embodiments of the present invention. One or more networked client computers 130 132 134 136 connects to server computer 110 through networks 140 112. The networks 140 112 between the client computers and the server computer may include plurality of components such as routers, switches, firewalls, content filters, proxies and other hardware that route the data transmitted between the client and server computers. The networks between the client computer and server can be a public 112 or a private 140 network or a combination thereof. The client computers 130 132 134 136 are computing devices such as a personal computer, notebook computer, workstation, server, smart phone, or the like. The server computers 110 may be a web server that serves web pages in Hyper Text Markup Language (HTML) format to remote computers based on a received request formatted in accordance with the Hyper-Text transfer Protocol (HTTP). The web pages received at the client computers are processed by an application such as a web browser to display the content.

For the embodiment illustrated in FIG. 1, system 100 includes a validation server 140 that executes the active content validation process for web pages being transmitted to the client computer 130. The validation server 140 monitors all HTTP request and response messages between the client computer 130 and the server 110, extracts the active content from the web pages; compares them with a list of authenticated active content for that web page; removes any unauthenticated content including but not limited to scripts, JAVA files, executable files, and ActiveX plugins; and forwards the modified web page to the client. Any malicious script injected into the web page via a XSS attack will be removed and the attack will be defeated.

In an embodiment of the inventions, the validation server 150 executes a validation process 120 that may include several subcomponents, such as content validation process (CVP) 122, the content monitoring process (CMP) 124, and the rule database (RDB) 126. The RDB 126 contains a list of rules and it may be locally stored in the validation engine or reside at a remote server 160. The CVP 122 monitors HTTP requests and responses and is responsible for enforcement of the rules for the web pages being accessed by the client computers. The CMP 124 also monitors HTTP requests and responses to assist in creating new rules and for updating existing rules in the rule database 126. The rules in the RDB 126 may include a list of parameters that includes, but is not limited to, domain name, URL, active content type, active content cryptographic hash, and active content classification. This rule list in the RDB 126 can also be locally generated by monitoring active content from web pages accessed or it can be downloaded from a remote rule server 160.

The validation process 120 may be implemented in several ways. FIG. 1 shows one embodiment where the validation process 120 is part of a server 150 on the network and validates the active content in web pages before it reaches the client. When the validation process 120 is implemented on the network, it can function as a standalone device or as part of an existing network device such as a firewall, a content filter, or a router, but not limited to them. In another embodiment the present invention, the validation process is part of the client as a kernel module or an application or an application plug-in or a library. To a person well versed in the art, it will be obvious that the validation process can be implemented at any location between the web server 110 and the client 132. As long as the validation is applied before the web page is delivered to the final application at the client computer 132, the client computer is secure from unauthorized content in the web pages.

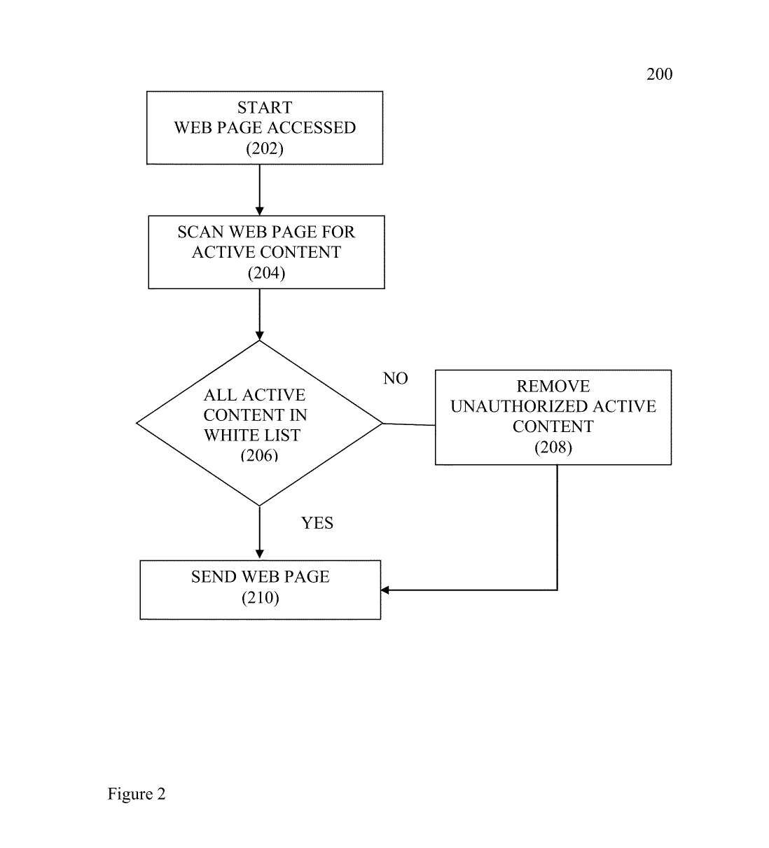

FIG. 2 is a block diagram of one embodiment of the present invention for validation of active content in web pages. When a client sends an HTTP request to access a web page and the server responds with content of the web page as an HTML file, the content validation process starts 200, block 202. As shown in the block 204 of FIG. 2, the content validation program scans the contents of the received web page to find all active content. The list of active content is checked against the white list of the rule database, block 206. If all active content detected in the web page is in accordance with the white list, then the page is forwarded to the client, block 210. In the event the received web page contains active content that is not consistent with the white-list, that active content is removed from the web page and the modified web page is forwarded to the client, block 210. If the active component is not a self-contained element of the HTML data object model (DOM) tree, but part of another element, then that entire DOM element is validated.

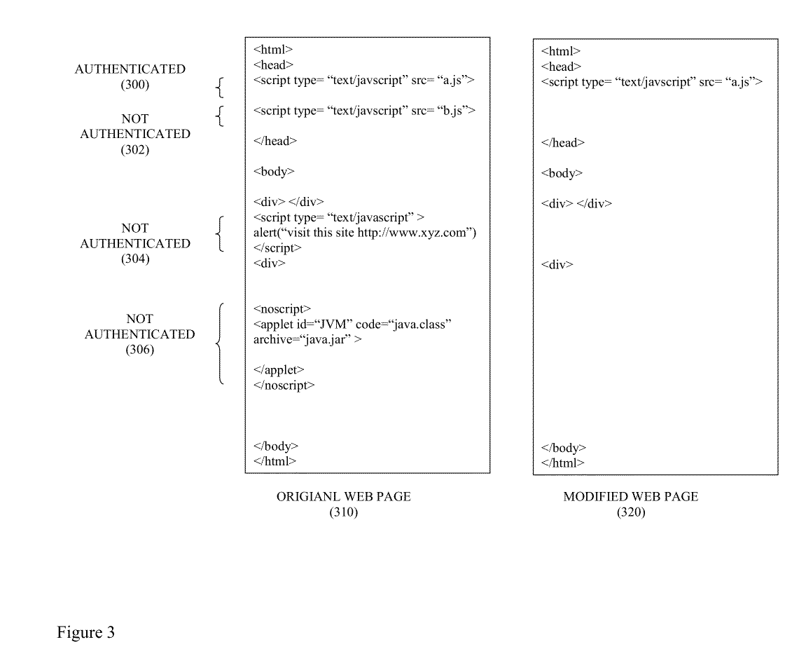

FIG. 3 illustrates a sample transformation of web page requested by the client. The content validation process scans the received web page 310 from the web server and finds four active contents 300 302 304 306. Comparison of the detected active content against the white-list in the rule database classifies active content 300 as valid and the remaining two active contents 302 304 306 as invalid. The modified web page 320 has the unauthorized active contents 302 304 306 removed and this modified web page is forwarded to the client.

Because the modification of a web page changes the size of the page, the in-line implementation of content validation is better achieved as a proxy server. The use of a proxy server overcomes the challenge associated with changes in individual network packet size when active content is removed from them. In another embodiment of the present invention where the in-line implementation of content validation is not a proxy server, the size of packets from which content is removed can be preserved by adding content that is not visible in web pages. When the content validation is implemented at the client, similar issues may arise if the implementation is at the transport layer or lower in the open systems interconnect (OSI) stack. However, if the implementation is above the session/transport layer, then the process is greatly simplified because the filtering is performed on the re-assembled web page and not on packets that contain only part of the web page. Web servers often encrypt web pages to improve security and confidentiality of data being accessed by the clients. When the web pages are transmitted in encrypted form, the plain-text of the web page is not accessible for validating the active content. SSL is the protocol used for encrypting all HTTP communications between the client and the web server. In one embodiment of the present invention, the validation server launches a MITM attack on all encrypted sessions to act as a proxy and gains access to the unencrypted plain-text of the web page. In another embodiment of the present invention, the validation server uses a key escrow system to decrypt the encrypted communications.

In one embodiment of the present invention, the rule database 126 is continually updated as client computers access web pages. As shown in FIG. 1, the content monitoring process 124 monitors every web page request and response messages. In another embodiment, this information is collected by a web crawler that uses a database of domain names to recursively traverse web pages of those domains. Each observed web page is examined for active content and the collected information is reported to the rule server 160. The rule server analyzes all collected data for any given web page for consistency with other samples collected from plurality of clients. The samples can also be collected via a direct HTTP request sent by the rule server 160 to the web server 100. A rule is created if all observations of active content in a web page are consistent with each other. In another embodiment, when active content observed in a web page is not consistent and outliers are detected, a fresh HTTP request is made to the web page and a rule is created based on the received response. In yet another embodiment, the behavior of active content is analyzed before it is added to the white-list rule database. The updated rules are sent back to the RDB 126. While the embodiment discussed here relies on the rule server 160 to perform the analysis, it is not limited to it. The analysis of active content in the web page and generation of rules can also be performed locally at the enforcement point 150.

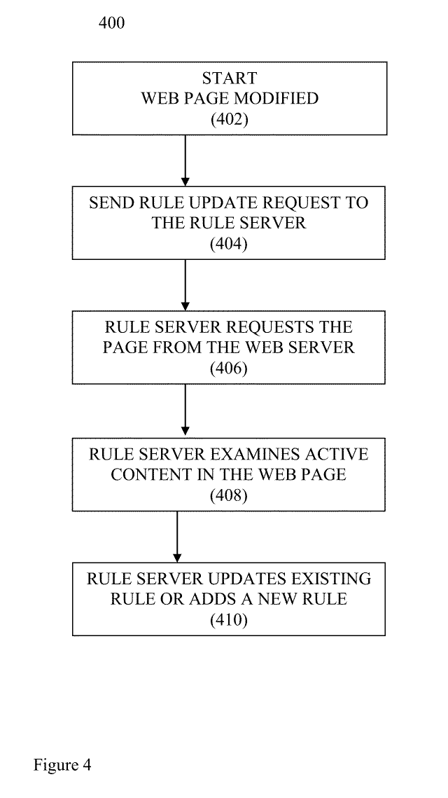

A potential cause for inconsistencies in observed active content of any given web page might be due to a legitimate update of the web page. In one embodiment of the present invention the creator of the web server can request update of the validation rules. FIG. 4 illustrates an embodiment of the process 400 for updating an existing rule or creating a new rule. The web server initiates the process by submitting a validation request for a newly updated web page to the rule servers, block 402. Upon receiving the request for validation, the rule server sends a HTTP request for that page and updates the existing rules for that page based on the new active content observed in that page, block 404. In the event a rule does not exist, the rule server creates a new rule. Some web pages may not be easily accessible to the rule server because the web server may require authentication in order to permit access to those pages. To address such special cases, the request for update from the web server 110 may include the active content that is part of the web page. This enables the rule server 160 to create a rule for web pages that require authentication. In another embodiment of the present invention, the request for rule update from the web server may supply the rule for the web page. These examples illustrate methods for creating or updating rules, but are not limited to them.

Thus, it is seen that systems and methods for validation of active content in web pages are provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

### REFERENCES

[1] Symantec Internet Security Threat Report 2007.
http://eval.symantec.com/mktginfo/enterprise/white_papers/b-whitepaper_exec_summary_internet_security_threat_report_xiii_{—}04-2008.en-us.pdf
[2] Top ten web risks.
https://www.owasp.org/index.php/Top_{—}10_{—}2013-Top_{—}10
[3] SANS Top software error
http://software-security.sans.org/blog/2010/02/22/top-25-series-rank-1-cross-site-scripting/
[4] Kausik et al., “Stateful application firewall”, U.S. Pat. No. 8,161,538.
[5] NoScript Firefox extension.
http://noscript.net
[6] IE 8 Security Part IV: The XSS Filter
http://blogs.msdn.com/b/ie/archive/2008/07/02/ie8-security-part-iv-the-xss-filter.aspx
[7] Hegli et al., “System and method for developing a risk profile for an internet service”, U.S. Pat. No. 8,438,386.
[8] Davenport et al., “System and method for run-time attack prevention”, U.S. Pat. No. 8,522,350.
[9] Dunagan et al., “Detouring in scripting systems”, U.S. Pat. No. 8,522,200.
[10] Sterland et al., “Separate script context to isolate malicious script”, U.S. Pat. No. 8,505,070.

What is claimed:

1. A method for validating active content in a web page comprising steps of:
intercepting a web page being transmitted from a server to a client;
listing items in a web page that represent active content including, but not limited to, scripts, ActiveX plugins, JAVA files, and executable files;
listing attributes of the said items;
computing cryptographic hash of the said items;
matching the attributes of said items with a white list database;
removing items from the web page that failed the white list match;
forwarding the modified page to its intended destination.

2. The method of claim 1 wherein the removed active content is replaced with HTML text so that the size of the original HTML file remains unchanged.

3. The method of claim 1 wherein the validation is performed at a location on the network.

4. The method of claim 1 wherein the validation is performed at the client.

5. The method of claim 1 wherein the validation is applied to a DOM element.

6. The method of claim 1 wherein an unknown active content in the web page is analyzed in a virtual environment and added to the rule list.

7. The method of claim 1 wherein any unknown active content in the web page is reported to a rule server and the corresponding rule is received.

8. A method for validating active content in an encrypted web page comprising steps of:
intercepting a web page being transmitted from a server to a client;
detecting the start of a SSL session;
generating a digital certificate for the target of the URL;
launching a MITM attack to act as a proxy;
listing items that represent active content including, but not limited to, scripts, JAVA files, and executable files;
listing attributes of the said items;
computing cryptographic hash of the said items;
matching the attributes of said items with a white list database;
removing items from the web page that failed the white list match;
forwarding the modified page to its intended destination.

9. The method of claim 8 wherein the removed active content is replaced with HTML text so that the size of the original HTML file remains unchanged.

10. The method of claim 8 wherein the validation is performed at a location on the network.

11. The method of claim 8 wherein the validation performed at the client.

12. The method of claim 8 wherein the validation is applied to a DOM element.

13. The method of claim 8 wherein an unknown active content in the web page is analyzed in a virtual environment and added to the rule list.

14. The method of claim 8 wherein any unknown active content in the web page is reported to a rule server and the corresponding rule is received.

15. A method for creating and updating white list rules for use in validating active content in a web page comprising steps of:
a web server, upon updating or creating a web page, sending a request to a rule server to update white list for the said web page;
accessing the web page;
scanning the received web page for active content;
listing attributes of the said items;
computing cryptographic hash of the said items;
creating new white list rules for the web page.

16. A method for creating and updating white list rules for use in validating active content in a web page comprising steps of:
a web crawler, using list of domain names and web pages, sending a request to access said web page;
accessing the web page;
scanning the web page for active content;
listing attributes of the said items;
performing static and dynamic analysis of active content to ensure that no malicious actions exist in the said items;
computing cryptographic hash of the said items;
creating new white list rules for the web page.

17. The method of claim 16 wherein the crawler is an in-line network device and passively monitors the HTTP traffic to generate white-list rules.
